(19) United States
(12) Patent Application Publication
(10) Pub. No.: US 2026/0093958 A1
(43) Pub. Date: Apr. 2, 2026

(54) METHODS AND APPARATUSES FOR TRAINING AND USING MULTI-TASK MACHINE LEARNING MODELS FOR COMMUNICATION OF CHANNEL STATE INFORMATION DATA

(71) Applicant: Telefonaktiebolaget LM Ericsson (publ), Stockholm (SE)

(72) Inventors: Konstantinos VANDIKAS, Solna (SE); Abdulrahman ALABBASI, Kista (SE); Roy TIMO, Kungsängen (SE)

(73) Assignee: Telefonaktiebolaget LM Ericsson (publ), Stockholm (SE)

(21) Appl. No.: 19/113,284

(22) PCT Filed: Nov. 28, 2022
(86) PCT No.: PCT/SE2022/051109

§ 371 Date: Mar. 19, 2025

(30) Foreign Application Priority Data
Sep. 23, 2022 (GR) 20220100778

(51) Int. Cl. G06N 3/0455

(52) U.S. Cl. CPC G06N 3/0455

(57) ABSTRACT

Embodiments described herein relate to methods and apparatuses for training a first machine learning, ML, model and a second ML model. A computer-implemented method of training a first ML model comprises: receiving a first latent space representation of a first channel state information, CSI, training data set, H1, from a first wireless device; decoding, using first parameters of the first ML model, the first latent space representation to determine a first reconstructed CSI data set; classifying, using second parameters of the first ML model, the first latent space representation to estimate an estimated classification; determining a first loss based on the estimated classification and a true classification; and updating the first parameters and the second parameters based on the determined first loss.

### TECHNICAL FIELD

Embodiments described herein relate to methods and apparatuses for training and using multi-task machine learning (ML) models for communication of Channel State Information data.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Channel State Information (CSI) compression is known in the state of the art as a solution for reducing the amount of data exchanged between a base station (e.g. a eNB/gNB) and a wireless device (e.g. a user equipment (UE)) when the two are setting up the properties of a physical communication channel. The technique may be based on an autoencoder which is split between the wireless device and the base station. The wireless device may be responsible for the encoder part of the autoencoder and the base station may be responsible for the decoder part of the autoencoder. The encoder module and the decoder module may either be trained together or one module can be frozen and the other trained based on the input of the encoder module (or the output of the decoder module) for the same data in a supervised manner where the loss function follows the reconstruction loss between the original input and the output of the autoencoder.

FIG. 1 illustrates an example overall design for an autoencoder 100 implemented by different parties (e.g. a wireless device 101 and a network node 102). The encoder 103 may be trained by the wireless device or Chipset vendor while the decoder 104 may be trained by the base station or Telecom vendor. A Channel data service (CDS) 105 may be standardized by 3GPP and may provide a common dataset (e.g., training data) which may be shared across the different vendors for the purpose of producing high quality autoencoders that perform well in different environments.

The main limitation in the approach illustrated in FIG. 1 appears in a multi-vendor setup. For example, different vendors may produce different UEs, so for a first base station, a decoder module may be required for each respective UE vendor. Similarly, for a first wireless device an encoder module may be required for each respective base station/telecom vendor. In other words, the multi-vendor setup naturally enforces multiple pairs of encoders and decoders for every combination between a UE/chipset vendor and a gNB/Telecom network equipment vendor.

The main disadvantage to the provision of multiple such pairs is the amount of time it may take for a base station or a wireless device to switch between decoder or encoder modules respectively. The switch entails copying the arch and weights of each encoder or decoder module every time such a change occurs. This copying may take time due to the large volume of encoder and/or decoder modules and requires enough available memory.

This problem may potentially be solved by equipping either or both devices (UEs and gNBs) with more memory to allow for the storage of all possible pairs of encoders/decoders but that can be wasteful and increase the cost of each device.

Other possible solutions in the multi-vendor setup are, for example: using federated learning to average all modules into one single encoder or decoder; implementing different light-weight adaptation layers via distance learning; or domain adaptation which learn ways to adapt the input to the decoder without the need to switch between autoencoders. However, these approaches require additional training effort and signaling, and are not native to the end-to-end training process of an autoencoder.

### SUMMARY

According to some embodiments there is provided a computer-implemented method of training a first ML model. The method comprises receiving a first latent space representation of a first channel state information, CSI, training data set, H1, from a first wireless device; decoding, using first parameters of the first ML model, the first latent space representation to determine a first reconstructed CSI data set; classifying, using second parameters of the first ML model, the first latent space representation to estimate an estimated classification; determining a first loss based on the estimated classification and a true classification; and updating the first parameters and the second parameters based on the determined first loss.

According to some embodiments there is provided a method of training a second ML model associated with a first wireless device. The method comprises encoding, using first parameters of the second ML model, a first channel state information, CSI, training data set, H1, and an identification of a first vendor to generate a first latent space representation; transmitting the first latent space representation to a first network node; classifying, using second parameters of the second ML model, the first CSI training data set and the identification of the first vendor to generate an estimated classification; determining a first loss based on the estimated classification and a true classification; and updating the first parameters and the second parameters based on the determined first loss.

According to some embodiments there is provided a training apparatus for training a first ML model. The training apparatus comprises processing circuitry configured to cause the training apparatus to: receive a first latent space representation of a first channel state information, CSI, training data set, H1, from a first wireless device; decode, using first parameters of the first ML model, the first latent space representation to determine a first reconstructed CSI data set; classify, using second parameters of the first ML model, the first latent space representation to estimate an estimated classification; determine a first loss based on the estimated classification and a true classification; and update the first parameters and the second parameters based on the determined first loss.

According to some embodiments there is provided a training apparatus for training a second ML model. The training apparatus comprises processing circuitry configured to cause the training apparatus to: encode using first parameters of the second ML model, a first channel state information, CSI, training data set, H1, and an identification of a first vendor to generate a first latent space representation; transmit the first latent space representation to a first network node; classify, using second parameters of the second ML model, the first CSI training data set and the identification of the first vendor to generate an estimated classification; determine a first loss based on the estimated classification and a true classification; and update the first parameters and the second parameters based on the determined first loss.

Aspects and examples of the present disclosure thus provide methods and apparatuses for training a first ML model and a second ML model. In particular the models may be utilised to transmit CSI between a base station and a plurality of wireless devices.

As opposed to training an agnostic autoencoder, (e.g. an autoencoder that is not aware of the UE vendor or the base station vendor) the proposed embodiments performs better as the combination of the two tasks (reconstruction of the CSI and learning of the classification) enhances the reconstruction of the latent space thus better captures characteristics of the wireless device's encoder module or the network node's decoder module which are not expected to be the same and thus yield different representations. Moreover, the proposed embodiments achieve the same effect while maintaining a single pair of autoencoders, thus overcoming the need to switch between different implementations.

Embodiments described herein are also robust in the context of a malicious environment where either the wireless device or the network node may be communicating false identities in order to throw the classification process.

For the purposes of the present disclosure, the term “ML model” encompasses within its scope the following concepts:

Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task. References to “ML model”, “model”, model parameters”, “model information”, etc., may thus be understood as relating to any one or more of the above concepts encompassed within the scope of “ML model”.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example overall design for an autoencoder implemented by different parties;

FIG. 2 illustrates an example of an autoencoder for use in transmitting CSI between a wireless device and a network node;

FIG. 3 illustrates a method of training a first ML model associated with a base station;

FIG. 4 illustrates an example implementation of the method of FIG. 3;

FIG. 5 illustrates an example implementation of the method of FIG. 3;

FIG. 6 illustrates a method of training a second ML model associated with a first wireless device;

FIG. 7 illustrates an example implementation of the method of FIG. 6;

FIG. 8 illustrates an example implementation of the method of FIG. 6;

FIG. 9 illustrates a training apparatus comprising processing circuitry;

FIG. 10 is a block diagram illustrating a training apparatus according to some embodiments;

FIG. 11 illustrates a training apparatus comprising processing circuitry;

FIG. 12 is a block diagram illustrating a training apparatus according to some embodiments.

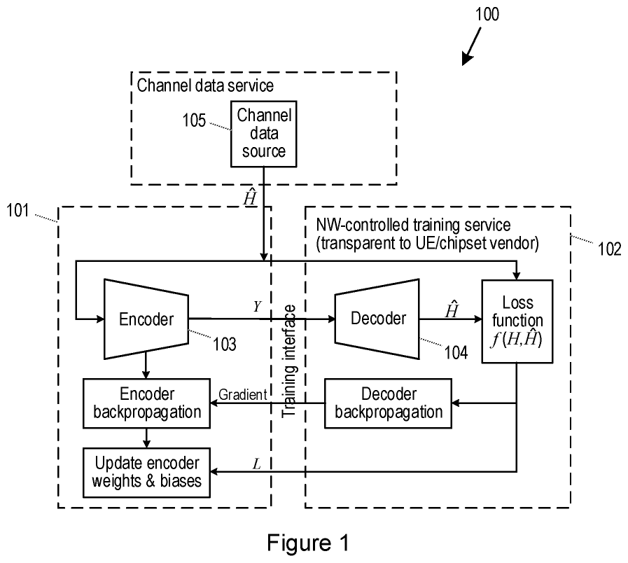

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments described herein relate to methods and apparatuses configured to leverage multi-task learning in the training of the autoencoder which enables the decoder module to learn which UE/chipset vendor CSI data is originating from, and the encoder module to learn which base station (or network node) vendor the CSI data is being transmitted to, and to encode the data accordingly.

Multi-task learning comprises a subfield of machine learning in which multiple learning tasks are solved at the same time, while exploiting commonalities and differences across tasks.

By performing multi-task learning, the encoder and/or decoder modules may adjust their representations accordingly without the need for averaging or the need for implementing ways of adapting the model for each request.

For example, therefore, some embodiments described herein implement a classification component to the training of the encoder module and/or the decoder module with a combined loss function which can be used to improve the task of the reconstruction loss in a multi-vendor setting by learning from the classification task. In embodiments described herein the classification task comprises a task to learn learn which UE/chipset vendor CSI data is originating from and/or to learn which base station (or network node) vendor the CSI data is being transmitted to. In this way, the autoencoder becomes aware of the wireless device/chipset vendor and/or the base station/telecom vendor and can construct or reconstruct each latent space in a way that is aware of the specificities of each other.

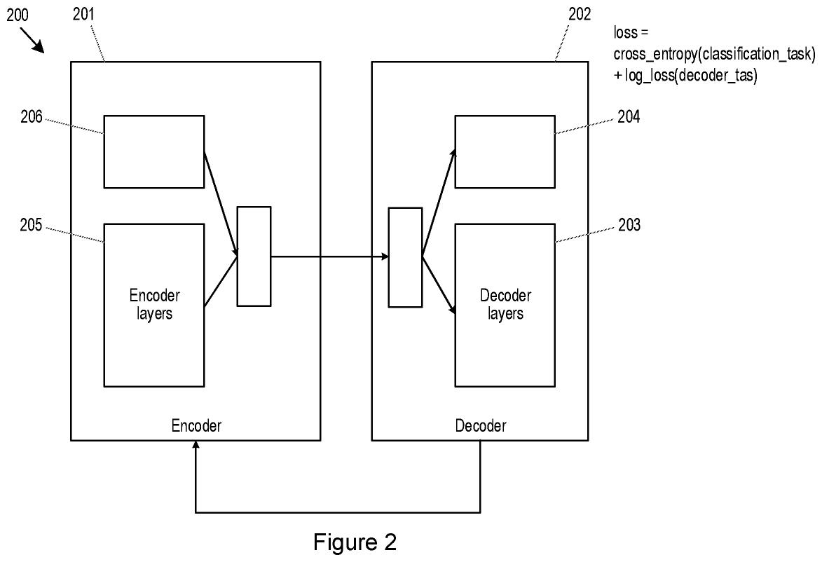

FIG. 2 illustrates an example of an autoencoder 200 for use in transmitting CSI between a wireless device and a network node (e.g. a base station) according to some embodiments.

The autoencoder 200 comprises an encoder module 201 and a decoder module 202. The encoder module 201 may be associated with a wireless device. For example, a first wireless device may comprise the encoder module 201. The decoder module 202 may be associated with a network node. For example, a first network node may comprise the decoder module 202.

The autoencoder 200 may be configured to transmit compressed channel state information (CSI) between the encoder module 201 and the decoder module 202.

The decoder module 202 comprises a first neural network comprising first decoder layers 203. The first decoder layers 203 of the first neural network may be configured to utilise first parameters. The first decoder layers 203 of the first neural network may be configured to decode latent space representations received from the encoder module.

The first neural network further comprises second decoder layers 204. The second decoder layers 204 of the first neural network utilise second parameters. The second decoder layers 204 of the first neural network may be configured to classify the latent space representations received from the encoder module to estimate a first indication C1\hat{ } indicative of a first vendor C1 associated with the first wireless device.

The first parameters and the second parameters may comprise weights of the connections in the neural networks of the first layers 203 and the second layers 204 respectively.

It will be appreciated that first parameters and the second parameters may be the shared between the first decoder layers of the first neural network and the second decoder layers of the first neural network. In other words, hard parameter sharing may occur between the first decoder layers of the first neural network and the second decoder layers of the first neural network. In hard parameter sharing parameters of the hidden layers for the first decoder layers and the second decoder layers may be set to be the same, while the task-specific output layers are different.

In some examples however, soft parameter sharing may be used and a distance between the first parameters and the second parameters may be regulated. In soft parameter sharing the first decoder layers and the second decoder layers may have their own different hidden layers, but difference in the weights used in these hidden layers may be regulated.

The encoder module 201 may comprise a second neural network comprising third encoder layers 205. The third encoder layers 205 of the second neural network utilise third parameters. The third encoder layers 205 of the second neural network may be configured to encode CSI data and a classification to form latent space representations to be transmitted to the decoder module 202.

The second neural network further comprises fourth encoder layers 206. The fourth encoder layers 206 of the second neural network may utilise fourth parameters. The fourth encoder layers 206 of the second neural network may be configured to classify the CSI data and the classification to estimate a second classification indicative of a second vendor associated with the first network node comprising the decoder module 202.

The third parameters and the fourth parameters may comprise weights of the connections in the neural networks of the third encoder layers 203 and the fourth encoder layers 204 respectively.

It will be appreciated that third parameters and the fourth parameters may be the shared between the third encoder layers of the second neural network and the fourth encoder layers of the second neural network. In other words, hard parameter sharing may occur between the third encoder layers of the second neural network and the fourth encoder layers of the second neural network.

In some examples however, soft parameter sharing may be used and a distance between the third parameters and the fourth parameters may be regulated.

The decoder module 202 may therefore be tasked to implement both classification of the latent space (e.g. using the second decoder layers 204) and the reconstruction of the CSI data encoded by the encoder module 201 (e.g. using the first decoder layers 203). Both tasks are combined by using a single loss function which may optionally be used to train the encoder module 201 if that is needed, or may just be used to train the decoder module 202.

Since the tasks of classification and reconstruction are combined, the decoder module 202 is trained to be good at both identifying the first vendor associated with the first wireless device (using classification) but also customising the reconstruction of the compressed latent space according to the identification of the first vendor. During the training process the first vendor does not send any information about its identity via the latent space. However, the decoder module 202 may already be aware of the first vendor identity as it may be provided by the CDS during the training process or may be derived by the decoder module using a clustering algorithm.

Similarly to as described above with reference to the decoder module 202, the encoder module 201 may also be tasked to implement two tasks: a classification task and an encoding task. The classification of the CSI data (e.g. using the third encoder layers 206) may determine the identity of the second vendor associated with the first network node, and the encoding of the CSI data may determine the latent spaces to be transmitted to the decoder module 202. Both tasks are combined by using a single loss function determined based on gradients received from the decoder module 202.

Since the tasks of classification and encoding are combined, the encoder module 201 is trained to be good at both identifying the second vendor associated with the second wireless device (using classification) but also customising the encoding of the CSI data according to the identification of the second vendor.

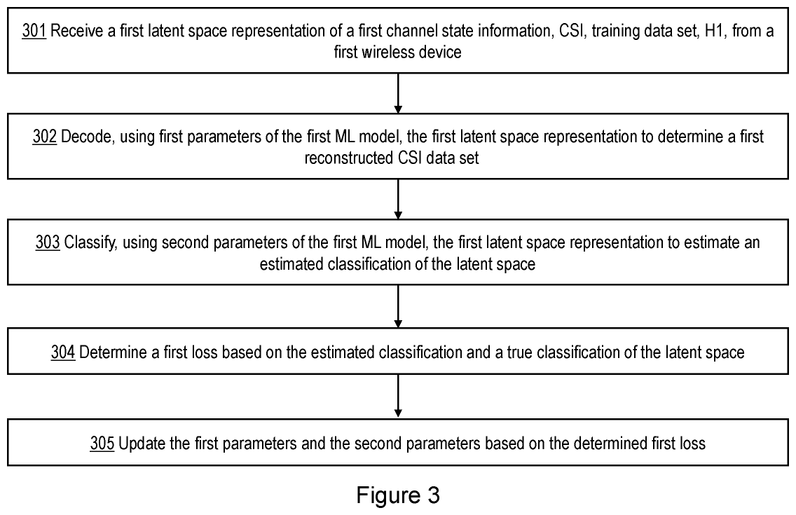

FIG. 3 illustrates a method of training a first ML model. The first ML model may comprise a decoder module of an autoencoder, wherein the decoder module is associated with a first network node. The method may be for example by performed by a decoder module 202 as illustrated in FIG. 2.

The method 300 may be performed by the first network node, which may comprise a physical or virtual node, and may be implemented in a computing device or server apparatus and/or in a virtualized environment, for example in a cloud, edge cloud or fog deployment. The first network node may for example comprise a base station (e.g., an eNB, a gNB or an equivalent Wifi base station or access point). It will be appreciated that the first network node may comprise a distributed base station, and the different steps of the method may be performed by any part of the distributed base station.

In step 301 the method comprises receiving a first latent space representation of a first channel state information, CSI, training data set from a first wireless device.

In step 302, the method comprises decoding, using first parameters of the first ML model, the first latent space representation to determine a first reconstructed CSI data set. As described with reference to FIG. 2, the first parameters may comprise parameters associated with first layers of a neural network in the decoder module 202. For example, the first parameters may comprise the weights of the first layers of the neural network in the decoder module 202. For example, step 302 may comprise decoding the first latent space representation using first layers of a neural network comprising the first parameters.

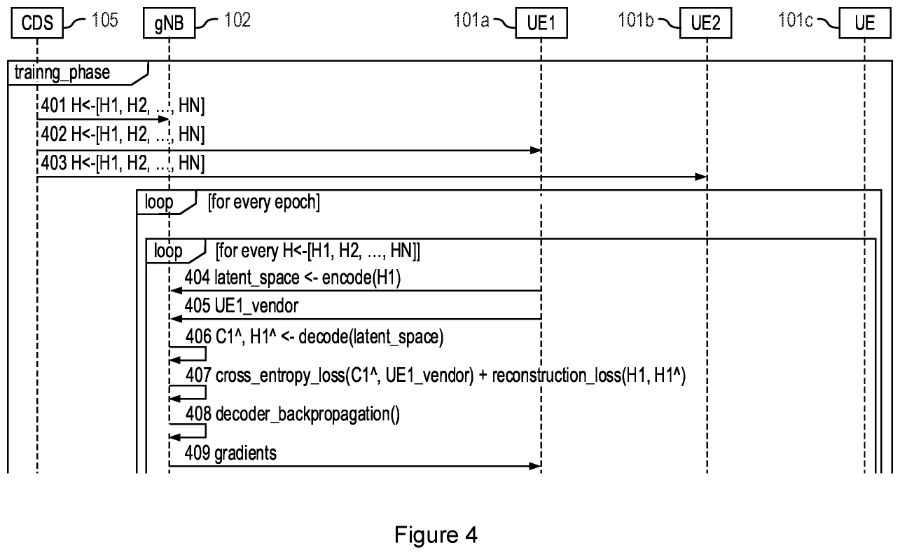

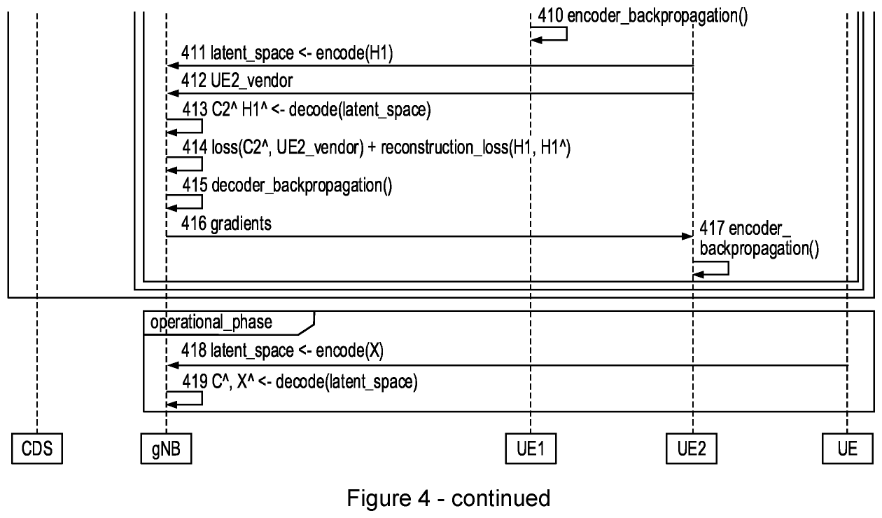

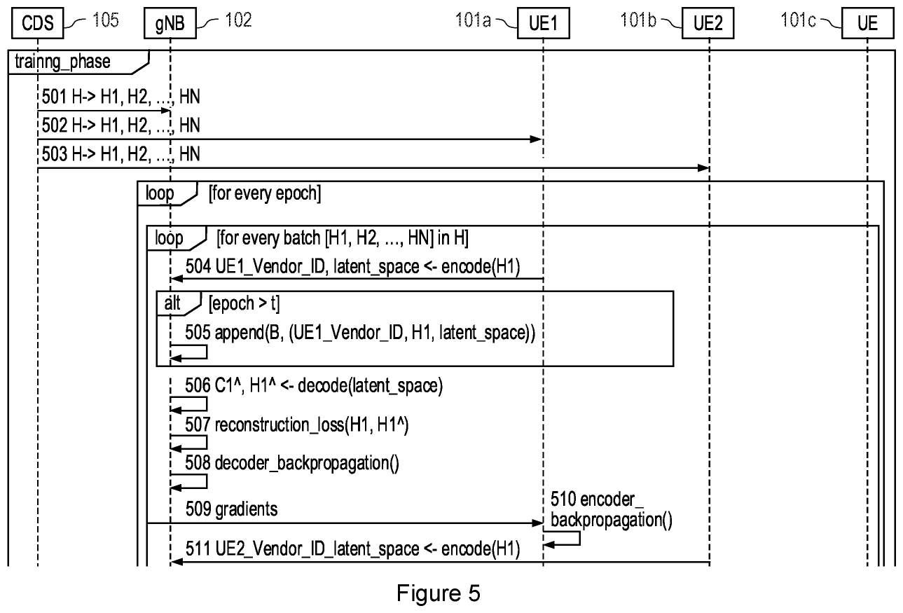

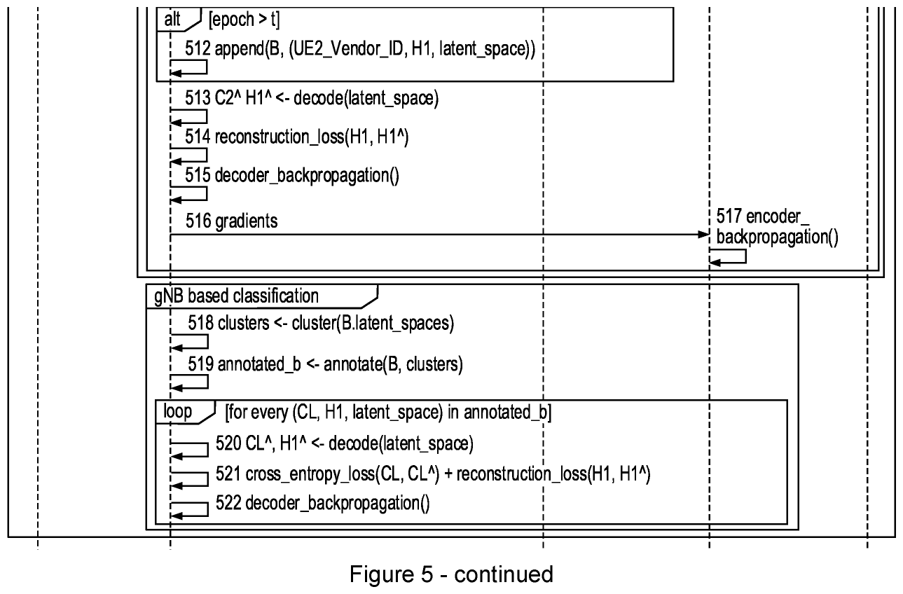

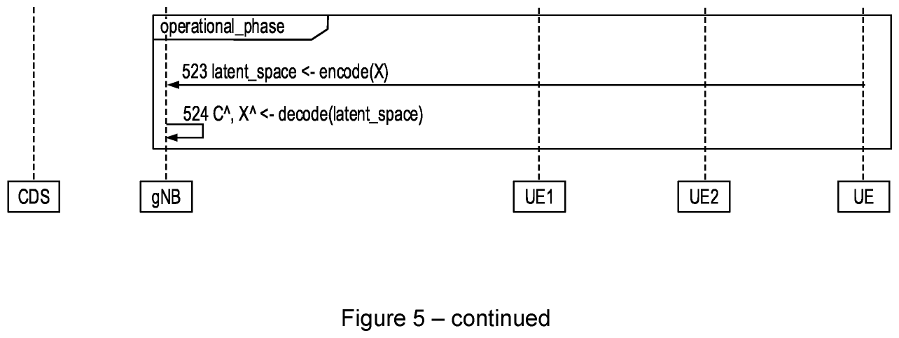

In step 303, the method comprises classifying, using second parameters of the first ML model, the first latent space representation to estimate an estimated classification. The first latent space representation may be classified in a way that is indicative of a first vendor associated with the first wireless device. For example, the estimated classification may comprise an estimate of an identification of the first vendor of the first wireless device (e.g. as will be described in more detail with reference to FIG. 4). In other examples, the estimated classification may comprise an estimate of an identity value associated with a group of vendors comprising the first wireless device (e.g. as will be described in more detail with reference to FIG. 5).

As described with reference to FIG. 2, the second parameters may comprise parameters associated with second layers of a neural network in the decoder module 202.

For example, step 303 may comprise classifying the first latent space representation using second layers of a neural network comprising the second parameters. For example, the second parameters may comprise weights of the second layers of the neural network.

In step 304 the method comprises determining a first loss based on the estimated classification and a true classification. The true classification of the latent space representation may in some examples be received from the CDS (e.g. as described with reference to FIG. 4). In some embodiments, however (for example, where information received from the CDS or from wireless devices may not be trusted) the true classification may be determined using a clustering technique (e.g. as described with reference to FIG. 5).

The true classification may be indicative of the first vendor associated with the first wireless device. For example, the true classification may comprise an identification of the first vendor. In some examples, the true classification comprises an identity value associated with a group of vendors comprising the first vendor.

In step 305, the method comprises updating the first parameters and the second parameters based on the first loss determined in step 304. In other words, the parameters of the first ML model (e.g. a neural network of the decoder module 202) are updated based on the first loss.

In some examples, the first parameters and the second parameters are shared between the first layers of the neural network and the second layers of the neural network in the decoder module 202. In other words, in some examples hard parameter sharing occurs between the first layers and the second layers of the decoder module 202. In some examples, a distance between the first parameters and the second parameters is regulated. In other words, in some examples, soft parameter sharing occurs between the first layers and the second layers of the decoder module 202.

According to some embodiments a method is provided that comprises utilizing a first ML model trained according to the method of FIG. 3.

FIG. 4 illustrates an example implementation of the method of FIG. 3. In this example, supervised learning is utilised for the classification of the latent space. In this example, the method of FIG. 3 is performed by the base station 102.

In steps 401 to 403, a CDS 105 transmits CSI training data sets H1, . HN to a base station 102 and to wireless devices 101a and 101b. In other words, steps 401 to 403 provide the training data sets partitioned in batches from the CDS to the gNB and to two different UE chipset vendors.

Steps 404 to 417 are performed for every epoch of the training and for each training data set H1, . . . HN.

In step 404 a first wireless device 101a transmits a first latent space representation (latent_space) to the base station 102. The first latent space representation comprises an encoding of the training data set H1. Step 404 comprises an example implementation of step 301 of FIG. 3.

In step 405 the first wireless device 101a transmits a true classification to the base station 102. In this example, the true classification comprises an identification of the UE chipset vendor, UE1_vendor. In some examples, the true classification is received alongside the training data sets from the CDS.

In step 406, the base station 102 decodes, using first parameters of the first ML model, the first latent space representation to determine a first reconstructed CSI data set, H1\hat{ }. In step 406 the base station 102 also classifies using second parameters of the first ML model, the first latent space representation to estimate an estimated classification, C1\hat{ }. Step 406 comprises an example implementation of steps 302 and 303 of FIG. 3

In step 407, the base station 102 determines an overall loss associated with step 406. In this example, the overall loss comprises a sum of a first loss (in this example a cross entropy loss) and a reconstruction loss.

The first loss comprises a cross entropy loss associated with the estimated classification C1\hat{ } and the identification of the UE chipset vendor, UE1_vendor.

The reconstruction loss may be determined by comparing the first reconstructed CSI data set H1\hat{ } and the first CSI data set H1. The reconstruction loss may be calculated using a mean squared error.

Step 407 comprises an example implementation of step 304 of FIG. 3.

In step 408 the base station 102 updates the first parameters and the second parameters of the first ML model based on the overall loss (e.g. based on the first loss and the reconstruction loss). In this example, the base station 102 performs decoder backpropagation based on the overall loss calculated in step 407. Step 408 is an example implementation of step 305 in FIG. 3

It will be appreciated that in some examples, step 408 may be based on only the first loss.

In step 409 the base station 102 transmits, to the first wireless device 101a, one or more gradient values resulting from the decoder backpropagation in step 408. The first wireless device 101a may then utilize the gradient values received in step 409 to perform encoder backpropagation in step 410.

It will be appreciated that in some examples, the encoder in the first wireless device 101a is frozen, and that in these examples steps 409 and 410 may not be performed.

Steps 411 to 417 illustrate a repeat of steps 404 to 410 for the second wireless device 101b.

It will be appreciated that the steps 404 to 410 may be repeated for any number of wireless devices with any number of training data sets H1 to HN.

By performing multiple passes of these training steps the decoder module in the base station 102 may learn not only to decode the latent space representations based on the reconstruction losses, but also to classify the received latent space representations to determine the UE chipset vendor identifications.

This is possible because the latent space representations produced by a single UE chipset vendor may be in some way similar or effectively fingerprinted. A different UE chipset vendor may then produce latent space representations that are in some way different to another UE chipset vendors latent space representations.

Steps 418 and 419 illustrate the operational phase in which the trained first ML model is used.

In step 418, a wireless device 101c transmits a latent space representation to the base station 102. The latent space representation comprises an encoding of CSI data X. In step 419, the base station 102 decodes the latent space representation using the first ML model and outputs a reconstruction, X\hat{ }, of the CSI data X and a estimate of the identification of the UE chipset vendor C\hat{ }.

The approach in FIG. 4 relies on supervised learning and therefore trustworthy knowledge that the identification of the UE chipset vendor received from the wireless devices 101 (or in some cases received from the CDS) are correct.

However, in real life there can be scenarios where this information is incorrect. For example, a malicious CDS may be sharing corrupt data with incorrect labels or a UE maybe trying to impersonate another chipset vendor.

To solve these issues the embodiment of FIG. 4 may be enhanced with a mechanism that enables the base station to produce their own mechanism of classifying the latent space representations. This mechanism may be used to either to verify or override the input that is used when the models are being trained.

FIG. 5 illustrates an example implementation of the method of FIG. 3. In this example, unsupervised learning is utilised to perform classification of the latent space.

In steps 501 to 503, a CDS 105 transmits CSI training data sets H1, . . . HN to a base station 102 and to wireless devices 101a and 101b. In other words, steps 501 to 503 provide the training data sets partitioned in batches from the CDS to the base station and to two different UE chipset vendors.

Steps 504 to 517 may be performed for every epoch of the training and for each training data set H1, . . . HN.

In step 504 a first wireless device 101a transmits a first latent space representation (latent_space) to the base station 102. The first latent space representation comprises an encoding of the training data set H1. Step 504 comprises an example implementation of step 301 of FIG. 3. In step 504 the first wireless device 101a also an identification of the UE chipset vendor, UE1_vendor.

However, contrary to the example illustrated in FIG. 4, in this example, the identification of the UE chipset vendor received from the wireless device is not trusted.

In step 505, the base station 102 stores the first latent space representation alongside the first CSI training data set H1 and the identification of the UE chipset vendor. In this example, the base station 102 stores the aforementioned information in a buffer B.

In step 506, the base station 102 decodes, using first parameters of the first ML model, the first latent space representation to determine a first reconstructed CSI data set, H1\hat{ }. In step 506 the base station 102 also classifies, using second parameters of the first ML model, the first latent space representation to estimate an estimated classification, C1\hat{ }. Step 406 comprises an example implementation of steps 302 of FIG. 3. In this example, this initial estimated classification C1\hat{ } is not used to train the first ML model. This is because the received UE chipset vendor identification is not trusted.

In step 507 the base station 102 determines a reconstruction loss by comparing the first reconstructed CSI data set H1\hat{ } and the first CSI data set H1. The reconstruction loss may be calculated using a mean squared error.

In step 508, the base station 102 updates the first parameters and the second parameters of the first ML model based on the reconstruction loss. In some examples, only the second parameters of the first ML model are updated in step 508. In other words, only the parameters associated with layers of the neural network that perform the reconstruction of the latent space representation are updated.

In step 509, the base station 102 transmits, to the first wireless device 101a, one or more gradient values resulting from the decoder backpropagation in step 508. The first wireless device 101a may then utilize the gradient values received in step 509 to perform encoder backpropagation in step 510.

It will be appreciated that in some examples, the encoder in the first wireless device 101a is frozen, and that in these examples steps 509 and 510 may not be performed.

Steps 511 to 517 illustrate a repeat of steps 504 to 510 for the second wireless device 101b.

It will be appreciated that the steps 504 to 510 may be repeated for any number of wireless devices with any number of training data sets H1 to HN.

It will therefore be appreciated that by performing steps 504 and 511 for multiple wireless devices and multiple different training data sets the base station 102 will obtain a plurality of latent space representations of a respective plurality of CSI training data sets.

Steps 505 and 512 then store the plurality of latent space representations.

In step 518, the base station 102 applies a clustering algorithm to the plurality of latent space representations to determine a plurality of clusters of the plurality of latent space representations. Each cluster is tagged with a unique identity value, CL. It will be appreciated (as previously described) that latent space representations that are produced by the same UE chipset vendor will have similar attributes. These latent space representations will be clustered together. A clustering algorithm such as k-means may be used to perform step 518.

It will also be appreciated that some UE chipset vendors may produce latent space representations that have similar attributes, and in some cases a single cluster of latent space representations may comprise latent space representations from multiple UE chipset vendors.

The identity value, CL, associated with each cluster may therefore be considered indicative of one or more UE chipset vendors associated with the cluster. The identity values, CL, may be considered true classifications of the latent space representations.

In step 519, the base station 102 stores the annotated latent spaces in the buffer B.

In steps 520 to 522 the base station 102 may then train the classifying part of the decoder module. To do this training the base station 102 uses the stored latent space representations in the buffer B.

The steps 520 to 522 may therefore be performed for each latent space representation stored in the buffer B.

In step 520 the base station 102 decodes, using first parameters of the first ML model, a first latent space representation (e.g., one of the stored latent space representations) to determine a first reconstructed CSI data set, H1\hat{ }. In step 520, the base station 102 also classifies, using second parameters of the first ML model, the first latent space representation to estimate an estimated classification, CL\hat{ }. Step 520 comprises an example implementation of steps 302 and 303 of FIG. 3.

In step 521, the base station 102 determines an overall loss associated with step 520. In this example, the overall loss comprises a sum of a first loss (in this example a cross entropy loss) and a reconstruction loss.

The first loss comprises a cross entropy loss associated with the estimated classification CL\hat{ } and the true classification CL associated with the first latent space representation as determined in step 518. For example, the true classification CL may be found by determining that the first latent space representation belongs to a first cluster of the plurality of clusters; and determining that the true classification comprises a first tag identity value associated with first cluster

The reconstruction loss may be determined by comparing the first reconstructed CSI data set H1\hat{ } and the first CSI data set H1. The reconstruction loss may be calculated using a mean squared error.

Step 521 comprises an example implementation of step 304 of FIG. 3.

In step 522, the base station 102 updates the first parameters and the second parameters of the first ML model based on the overall loss (e.g. based on the first loss and the reconstruction loss). In this example, the base station 102 performs decoder backpropagation based on the overall loss calculated in step 521. Step 522 is an example implementation of step 305 in FIG. 3.

It will be appreciated that in some examples, step 522 may be based on only the first loss.

Steps 523 and 524 illustrate the operational phase in which the trained first ML model is used. It will be appreciated that the model may be trained as described above.

In step 523, a wireless device 101c transmits a latent space representation to the base station 102. The latent space representation comprises an encoding of CSI data X. In step 524, the base station 102 decodes the latent space representation using the first ML model and outputs a reconstruction, X\hat{ }, of the CSI data X and a estimate of a cluster identity value of the latent space representation C\hat{ }.

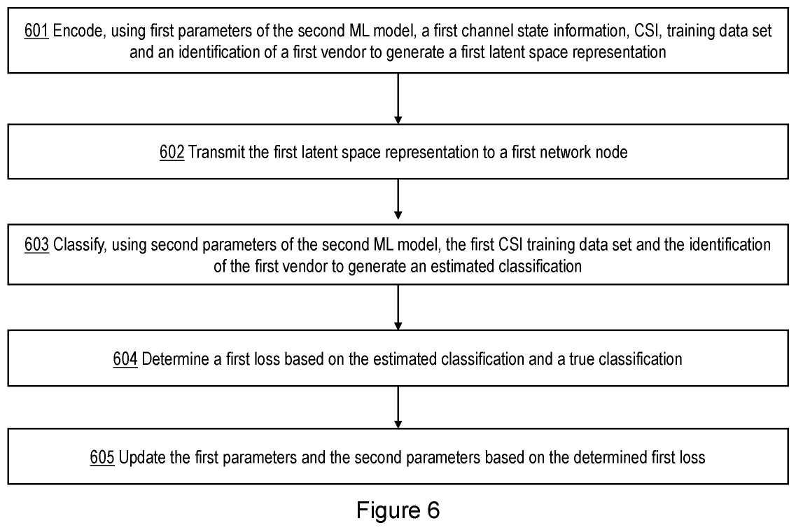

FIG. 6 illustrates a method of training a second ML model associated with a first wireless device. The second ML model may comprise an encoder module of an autoencoder, wherein the encoder module is associated with the first wireless device. The method may be for example by performed by an encoder module 201 as illustrated

The method 600 may be performed by a network node, which may comprise a physical or virtual node, and may be implemented in a computing device or server apparatus and/or in a virtualized environment, for example in a cloud, edge cloud or fog deployment. In some examples, the method 600 is performed by the first wireless device 101 (e.g. as illustrated in FIG. 2).

In step 601 the method comprises encoding, using first parameters of the second ML model, a first channel state information, CSI, training data set and an identification of a first vendor to generate a first latent space representation. It will be appreciated that the first parameters of the second ML model may comprise the third parameters as described with reference to FIG. 2.

The identification of the first vendor may comprise an Identification of a vendor of a base station to which the first wireless device is in communication. The identification of the vendor of the base station may be received from the base station, or from a CDS.

As described with reference to FIG. 2, the first parameters may comprise parameters associated with first layers of a neural network in the encoder module 202. For example, the first parameters may comprise weights of the first layers of the neural network in the encoder module 202. For example, step 601 may comprise encoding the first CSI training data set and the first vendor using first layers of a neural network comprising the first parameters.

In step 602, the method comprises transmitting the first latent space representation to a first network node.

In step 603, the method comprises classifying, using second parameters of the second ML model, the first CSI training data set and the identification of the first vendor to generate an estimated classification. It will be appreciated that the second parameters of the second ML model may comprise the fourth parameters as described with reference to FIG. 2.

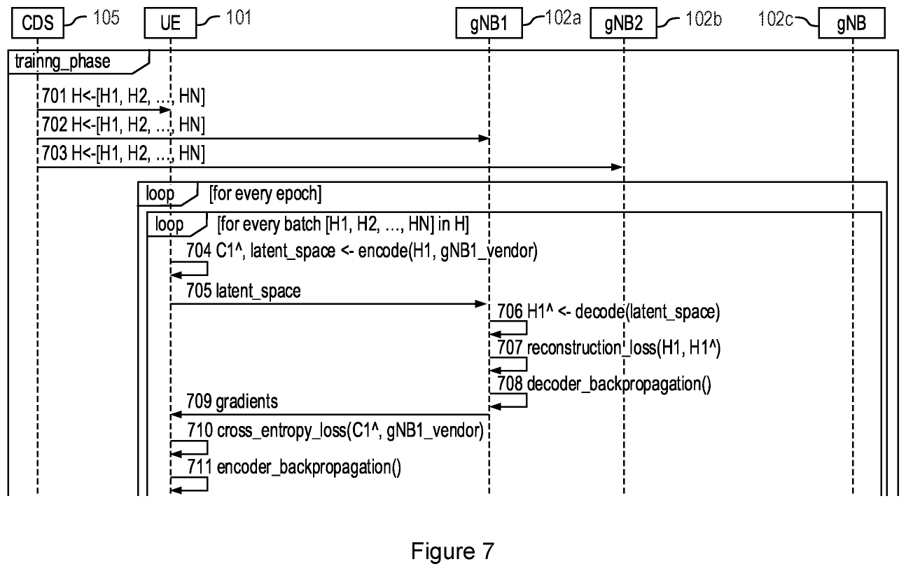

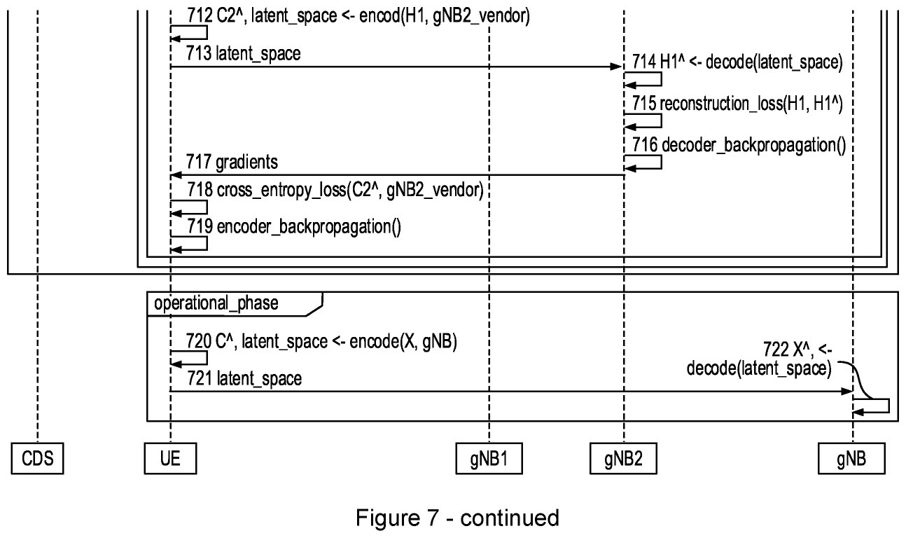

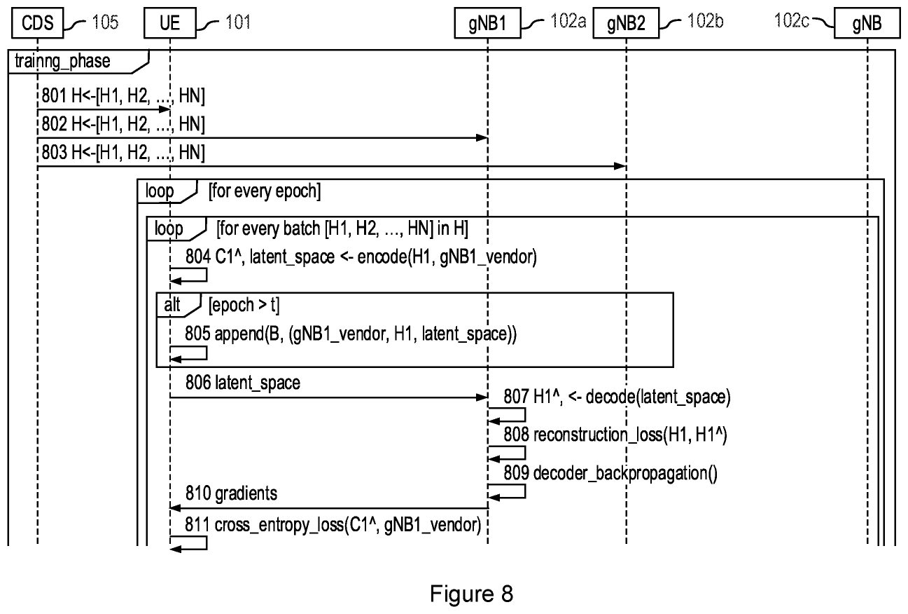

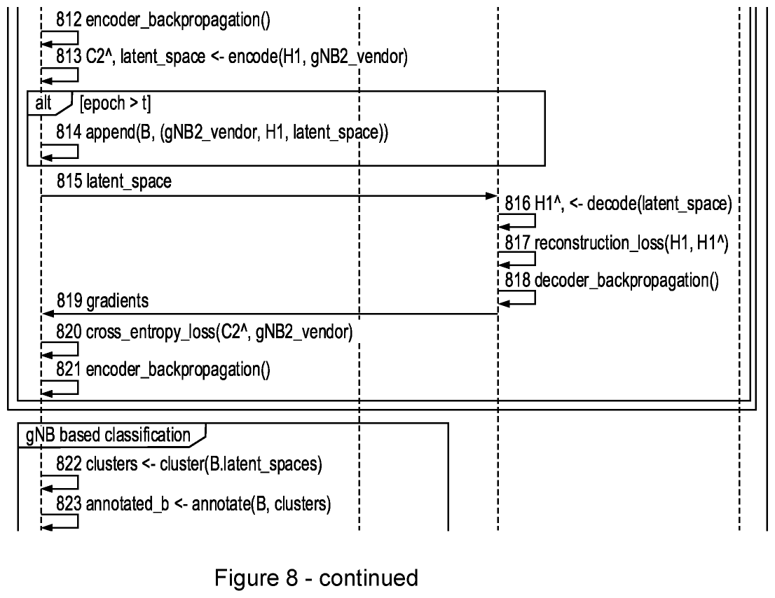

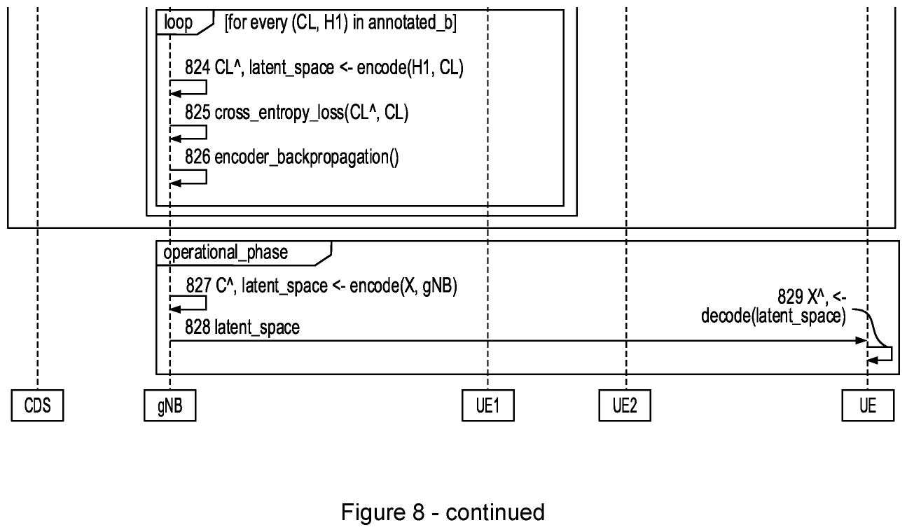

The first latent space representation may be classified in a way that is indicative of a first vendor associated with the first wireless device. For example, the estimated classification may comprise an estimate of an identification of the first vendor of the first wireless device (e.g. as will be described in more detail with reference to FIG. 7). In other examples, the estimated classification may comprise an estimate of an identity value associated with a group of vendors comprising the first wireless device (e.g. as will be described in more detail with reference to FIG. 8).

In step 604 the method comprises determining a first loss based on the estimated classification and a true classification. The true classification of the latent space may in some examples be received from the CDS or the first network node (e.g. during Radio Resource Control connection). In some embodiments, however (for example, where information received from the CDS or from the network node may not be trusted) the true classification may be determined using a clustering technique (e.g. as described with reference to FIG. 8). The first loss may comprise a cross entropy loss.

The true classification may be indicative of the first vendor associated with the first network node. For example, the true classification may comprise an identification of the first vendor. In some examples, the true classification comprises a identity value associated with a group of vendors comprising the first vendor.

In step 605 the method comprises updating the first parameters and the second parameters based on the determined first loss. In other words, the parameters of the second ML model (e.g. a neural network of the encoder module 201) are updated based on the first loss.

In some examples, the first parameters and the second parameters are shared between the first layers of the neural network and the second layers of the neural network in the encoder module 201. In other words, in some examples hard parameter sharing occurs between the first layers and the second layers of the encoder module 201. In some examples, a distance between the first parameters and the second parameters is regulated. In other words, in some examples, soft parameter sharing occurs between the first layers and the second layers of the encoder module 201.

According to some embodiments a method is provided that comprises utilizing a second ML model trained according to the method of FIG. 6.

FIG. 7 illustrates an example implementation of the method of FIG. 6. In this example, supervised learning is utilised for the classification of the latent space. In this example, the method of FIG. 6 is performed by wireless device 101.

In steps 701 to 703, a CDS 105 transmits CSI training data sets H1, . . . HN to the wireless device 101 and to base stations 102a and 102b. In other words, steps 701 to 703 provide the training data sets partitioned in batches from the CDS to the wireless device and to two different base station vendors.

Steps 704 to 719 are performed for every epoch of the training and for each training data set H1, . . . HN.

In step 704, the wireless device 101 encodes, using first parameters of the second ML model, a first channel state information, CSI, training data set (H1) and an identification of a first vendor (gNB1_vendor) to generate a first latent space representation (latent_space).

In step 704 the wireless device 101 may also classify, using second parameters of the second ML model, the first CSI training data set and the identification of the first vendor to generate an estimated classification. Step 704 comprises an example implementation of steps 601 and 603 of FIG. 6.

In step 705, the wireless device 101 transmits the first latent space representation to the first base station 102a. Step 705 corresponds to an example implementation of Step 602 of FIG. 6.

In step 706, the first base station 102a decodes the first latent space representation to generate a first reconstructed CSI data set, H1\hat{ }. The first base station 102a may use a first ML model to perform step 706 (for example a decoder module as described with reference to FIG. 2).

In step 707, the first base station 102a calculates a reconstruction loss (reconstruction_loss) based on the first reconstructed CSI data H1\hat{ } and the corresponding first training data set H1 received from the CDS in step 702.

In step 708, the first base station 102a updates the first ML model. For example, the first base station 102a may perform decoder backpropagation.

In step 709, the first base station 102a transmits one or more gradients to the wireless device. The gradients may result from the decoder backpropagation performed in step 708.

In step 710 the wireless device 101 determines a first loss based on the estimated classification and a true classification. In this example the first loss comprises a cross entropy loss between the identification of the first vendor used in step 704 and the estimated classification determined by the classification in step 704. Step 710 comprises an example implementation of step 604 of FIG. 6.

In step 711 the wireless device 101 updates the first parameters and the second parameters based on the determined first loss. For example, the wireless device 101 may perform encoder backpropagation. In some examples, step 711 is further based on the gradients received in step 709. Step 711 comprises an example implementation of step 605 of FIG. 6.

Steps 712 to 719 illustrate a repeat of steps 704 to 711 for the second base station 102b.

It will be appreciated that the steps 704 to 711 may be repeated for any number of wireless devices with any number of training data sets H1 to HN.

By performing multiple passes of these training steps, the encoder module in the wireless device 101 may learn not only to encode the CSI data sets in a customized manner for the different base station vendors, but also to classify the CSI data sets to determine the base station vendor identifications.

Steps 720 to 721 illustrate the operational phase in which the trained second ML model is used.

In step 720 the wireless device 101 encodes, using the trained second ML mode, CSI data X and an identification of a base station vendor, gNB, to generate a latent space representation and a classification C\hat{ }. In step 721, the wireless device 101 then transmits the latent space representation to a base station 102c.

In step 722 the base station 102c decodes the latent space representation using the first ML model and outputs a reconstruction, X\hat{ }.

The approach in FIG. 7 relies on supervised learning and therefore trustworthy knowledge that the identification of the base station received from the base stations 102 (or in some cases received from the CDS) are correct.

However, in real life there can be scenarios where this information is incorrect. For example a malicious CDS may be sharing corrupt data with incorrect labels or a base station maybe trying to impersonate another Telecom vendor.

To solve these issues the embodiment of FIG. 7 may be enhanced with a mechanism that enables the wireless device to produce their own mechanism of classifying the latent space representations. This mechanism may be used to either to verify or override the input that is used when the models are being trained.

FIG. 8 illustrates an example implementation of the method of FIG. 6. In this example, unsupervised learning is utilised to perform classification of the CSI training data.

In steps 801 to 803, a CDS 105 transmits CSI training data sets H1, . . . HN to a wireless device 101 and to base stations 102a to 102b. In other words, steps 801 to 803 provide the training data sets partitioned in batches from the CDS to the wireless device 101 and to two different base stations vendors.

Steps 804 to 821 may be performed for every epoch in the training and for each training data set H1, . . . HN.

In step 804, the wireless device 101 encodes, using first parameters of a second ML model, a first channel state information, CSI, training data set (H1) and an identification of a first vendor (gNB1_vendor) to generate a first latent space representation (latent_space). However, contrary to the example illustrated in FIG. 7, in this example, the identification of the first vendor received is not trusted.

In step 804 the wireless device 101 may also classify, using second parameters of the second ML model, the first CSI training data set and the identification of the first vendor to generate an estimated classification. Step 704 comprises an example implementation of steps 601 and 603 of FIG. 6.

In step 805, the wireless device 101 stores the first latent space representation alongside the first CSI training data set H1 and the identification of the first vendor. In this example, the wireless device 101 stores the aforementioned information in a buffer B.

In step 806, the wireless device 101 transmits the first latent space representation to the first base station 102a. Step 806 comprises an example implementation of step 602 of FIG. 2.

In step 807, the first base station 102a decodes the first latent space representation to generate a first reconstructed CSI data set, H1\hat{ }. The first base station 102a may use a first ML model to perform step 807 (for example a decoder module as described with reference to FIG. 2).

In step 808, the first base station 102a calculates a reconstruction loss (reconstruction_loss) based on the first reconstructed CSI data H1\hat{ } and the corresponding first training data set H1 received from the CDS in step 702.

In step 809, the first base station 102a updates the first ML model. For example, the first base station performs decoder backpropagation.

In step 810, the first base station 102a transmits one or more gradients to the wireless device. The gradients may result from the decoder backpropagation performed in step 809.

In step 811 the wireless device 101 determines a first loss based on the estimated classification and a true classification. In this example the first loss comprises a cross entropy loss between the identification of the first vendor used in step 804 and the estimated classification determined by the classification in step 804.

In step 812 the wireless device 101 updates the first parameters and the second parameters based on the determined first loss. For example, the wireless device 101 may perform encoder backpropagation. In some examples, step 812 is further based on the gradients received in step 809.

Steps 813 to 821 illustrate a repeat of steps 804 to 812 for the second base station 102b.

It will be appreciated that the steps 804 to 812 may be repeated for any number of base stations with any number of training data sets H1 to HN.

It will therefore be appreciated that by performing steps 804 and 812 for multiple base stations and multiple different training data sets the wireless device will obtain a plurality of latent space representations of a respective plurality of CSI training data sets.

Steps 805 and 812 then store the plurality of latent space representations.

In step 822, the wireless device applies a clustering algorithm to the plurality of latent space representations to determine a plurality of clusters of the plurality of latent space representations. Each cluster is tagged with a unique identity value, CL. These latent space representations will be clustered together. A clustering algorithm such as k-means may be used to perform step 818.

It will be appreciated that the identity value, CL, associated with each cluster may be considered indicative of one or more base station vendors associated with the cluster. The identity values, CL, may be considered true classifications of the latent space representations.

It will be appreciated that if a first vendor used in step 804 to generate a latent space is malicious, this may cause the attributes of the resulting latent space to be exotic, and therefore to force the latent space into a sparsely populated cluster.

Conversely, if such an latent space having exotic attributes ends up in a otherwise trusted cluster, then it may be assumed that the cluster is be mostly occupied by trustworthy attributes and their corresponding occupants. Therefore, in the majority of cases—the mapping will work as expected.

In step 823, the wireless device stores the annotated latent spaces in the buffer B.

In steps 824 to 826 the wireless device 101 may then train the classifying part of the decoder module. To do this training the wireless device 101 uses the stored latent space representations in the buffer B.

The steps 824 to 826 may therefore be performed for each latent space representation stored in the buffer B.

In step 824 the wireless device 101 encodes, using first parameters of the second ML model, a first channel state information, CSI, training data set and an true classification, CL, to generate a first latent space representation. Step 824 further comprises classifying the first CSI training data set and the true classification to determine an estimated classification CL\hat{ }.

In step 825, the wireless device 101 determines a first loss based on the estimated classification and a true classification. In this step, the first loss is calculated based on the true classification CL (e.g. as used in step 824) and the estimated classification CL\hat{ } (e.g. as determined in step 824).

In step 826, the wireless device 101 updates the first parameters and the second parameters based on the first loss. For example, the wireless device 101 may perform encoder backpropagation.

Steps 827 to 829 illustrate the operational phase in which the trained second ML model is used.

In step 827 the wireless device 101 encodes CSI data X and an identification of a base station vendor, gNB, using the second ML model to generate a latent space representation and a classification C\hat{ }. In step 828, the wireless device 101 then transmits the latent space representation to a base station 102c.

In step 829 the base station 102c decodes the latent space representation using the first ML model and outputs a reconstruction, X\hat{ }.

It will be appreciated that the embodiments illustrated in FIGS. 3 to 8 may be combined. For example, the clustering embodiments may be used to verify the trustworthiness of the received identification of the vendors, rather than replace them

It will also be appreciated that the encoder module embodiments and the decoder module embodiments may operate in parallel.

In other words, both a wireless device and a base station may be equipped with the corresponding encoder or decoder multi-task functionality as described herein, and may thus each learn to classify each other's latent space in addition to reconstructing it in parallel.

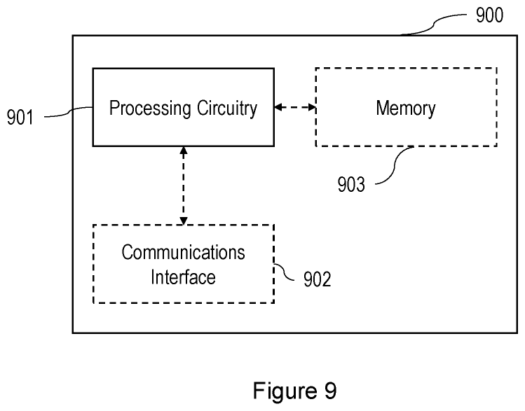

FIG. 9 illustrates a training apparatus 900 comprising processing circuitry (or logic) 901. The processing circuitry 901 controls the operation of the training apparatus 900 and can implement the method described herein in relation to an training apparatus 900. The processing circuitry 901 can comprise one or more processors, processing units, multi-core processors or modules that are configured or programmed to control the training apparatus 900 in the manner described herein. In particular implementations, the processing circuitry 901 can comprise a plurality of software and/or hardware modules that are each configured to perform, or are for performing, individual or multiple steps of the method described herein in relation to the training apparatus 900.

Briefly, the processing circuitry 901 of the training apparatus 900 is configured to: receive a first latent space representation of a first channel state information, CSI, training data set, H1, from a first wireless device; decode, using first parameters of the first ML model, the first latent space representation to determine a first reconstructed CSI data set; classify, using second parameters of the first ML model, the first latent space representation to estimate an estimated classification; determine a first loss based on the estimated classification and a true classification; and update the first parameters and the second parameters based on the determined first loss.

In some embodiments, the training apparatus 900 may optionally comprise a communications interface 902. The communications interface 902 of the training apparatus 900 can be for use in communicating with other nodes, such as other virtual nodes. For example, the communications interface 902 of the training apparatus 900 can be configured to transmit to and/or receive from other nodes requests, resources, information, data, signals, or similar. The processing circuitry 901 of training apparatus 900 may be configured to control the communications interface 902 of the training apparatus 900 to transmit to and/or receive from other nodes requests, resources, information, data, signals, or similar.

Optionally, the training apparatus 900 may comprise a memory 903. In some embodiments, the memory 903 of the training apparatus 900 can be configured to store program code that can be executed by the processing circuitry 901 of the training apparatus 900 to perform the method described herein in relation to the training apparatus 900. Alternatively or in addition, the memory 903 of the training apparatus 900, can be configured to store any requests, resources, information, data, signals, or similar that are described herein. The processing circuitry 901 of the training apparatus 900 may be configured to control the memory 903 of the training apparatus 900 to store any requests, resources, information, data, signals, or similar that are described herein.

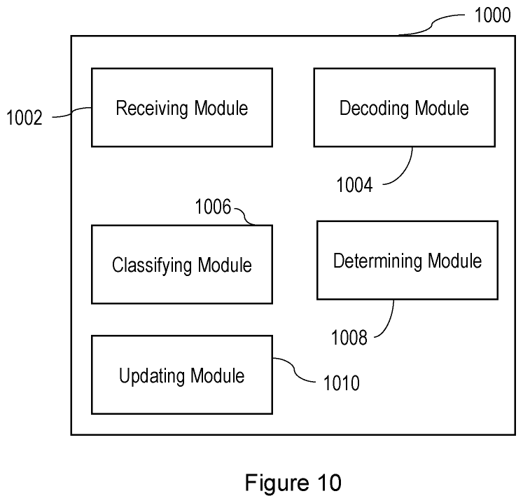

FIG. 10 is a block diagram illustrating a training apparatus 1000 according to some embodiments. The training apparatus 1000 can train a first ML model. The training apparatus 1000 comprises a receiving module 1002 configured to receive a first latent space representation of a first channel state information, CSI, training data set, H1, from a first wireless device. The training apparatus 1000 comprises a decoding module 1004 configured to decode, using first parameters of the first ML model, the first latent space representation to determine a first reconstructed CSI data set. The training apparatus 1000 comprises a classifying module 1006 configured to classify, using second parameters of the first ML model, the first latent space representation to estimate an estimated classification. The training apparatus 1000 comprises a determining module 1008 configured to determine a first loss based on the estimated classification and a true classification. The training apparatus 1000 comprises an updating module 1010 configured to update the first parameters and the second parameters based on the determined first loss. The training apparatus 1000 may operate in the manner described herein in respect of a training apparatus.

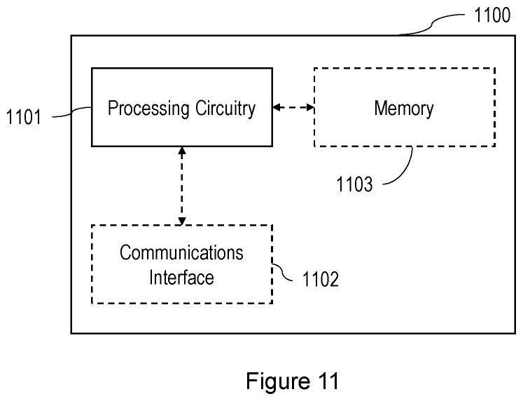

FIG. 11 illustrates a training apparatus 1100 comprising processing circuitry (or logic) 1101. The processing circuitry 1101 controls the operation of the training apparatus 1100 and can implement the method described herein in relation to an training apparatus 1100. The processing circuitry 1101 can comprise one or more processors, processing units, multi-core processors or modules that are configured or programmed to control the training apparatus 1100 in the manner described herein. In particular implementations, the processing circuitry 1101 can comprise a plurality of software and/or hardware modules that are each configured to perform, or are for performing, individual or multiple steps of the method described herein in relation to the training apparatus 1100.

Briefly, the processing circuitry 1101 of the training apparatus 1100 is configured to: encode using first parameters of the second ML model, a first channel state information, CSI, training data set, H1, and an identification of a first vendor to generate a first latent space representation; transmit the first latent space representation to a first network node; classify, using second parameters of the second ML model, the first CSI training data set and the identification of the first vendor to generate an estimated classification; determine a first loss based on the estimated classification and a true classification; and update the first parameters and the second parameters based on the determined first loss.

In some embodiments, the training apparatus 1100 may optionally comprise a communications interface 1102. The communications interface 1102 of the training apparatus 1100 can be for use in communicating with other nodes, such as other virtual nodes. For example, the communications interface 1102 of the training apparatus 1100 can be configured to transmit to and/or receive from other nodes requests, resources, information, data, signals, or similar. The processing circuitry 1101 of training apparatus 1100 may be configured to control the communications interface 1102 of the training apparatus 1100 to transmit to and/or receive from other nodes requests, resources, information, data, signals, or similar.

Optionally, the training apparatus 1100 may comprise a memory 1103. In some embodiments, the memory 1103 of the training apparatus 1100 can be configured to store program code that can be executed by the processing circuitry 1101 of the training apparatus 1100 to perform the method described herein in relation to the training apparatus 1100. Alternatively or in addition, the memory 1103 of the training apparatus 1100, can be configured to store any requests, resources, information, data, signals, or similar that are described herein. The processing circuitry 1101 of the training apparatus 1100 may be configured to control the memory 1103 of the training apparatus 1100 to store any requests, resources, information, data, signals, or similar that are described herein.

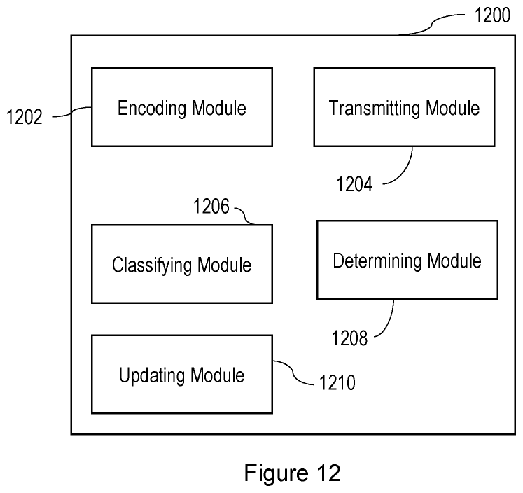

FIG. 12 is a block diagram illustrating a training apparatus 1200 according to some embodiments. The training apparatus 1200 can train a second ML model. The training apparatus 1200 comprises an encoding module 1202 configured to encode using first parameters of the second ML model, a first channel state information, CSI, training data set, H1, and an identification of a first vendor to generate a first latent space representation. The training apparatus 1200 comprises a transmitting module 1204 configured to transmit the first latent space representation to a first network node. The training apparatus 1200 comprises a classifying module 1206 configured to classify, using second parameters of the second ML model, the first CSI training data set and the identification of the first vendor to generate an estimated classification. The training apparatus 1200 comprises a determining module 1208 configured to determine a first loss based on the estimated classification and a true classification. The training apparatus 1200 comprises an updating module 1210 configured to update the first parameters and the second parameters based on the determined first loss. The training apparatus 1200 may operate in the manner described herein in respect of an training apparatus.

There is also provided a computer program comprising instructions which, when executed by processing circuitry (such as the processing circuitry 901 of the training apparatus 900 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

As opposed to training an agnostic autoencoder, (e.g. an autoencoder that is not aware of the UE vendor or the base station vendor) the proposed approach performs better as the combination of the two tasks enhances the reconstruction of the latent space thus better captures characteristics of the wireless devices encoder module or the network nodes decoder module which are not expected to be the same and thus yield different representations. Moreover, the proposed approach achieves the same effect while maintaining a single pair of autoencoders, thus overcoming the need to switch between different implementations.

Embodiments described herein are also robust in the context of a malicious environment where either the wireless device or the network node may be communicating false identities in order to throw the classification process.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer-implemented method of training a first machine learning (ML) model the method comprising:
receiving a first latent space representation of a first channel state information (CSI), training data set (H1), from a first wireless device;
decoding, using first parameters of the first ML model, the first latent space representation to determine a first reconstructed CSI data set;
classifying, using second parameters of the first ML model, the first latent space representation to estimate an estimated classification;
determining a first loss based on the estimated classification and a true classification; and
updating the first parameters and the second parameters based on the determined first loss.

2. The method of claim 1, wherein the first ML model comprises a decoder module of an autoencoder, and the decoder module is associated with a first network node.

3. The method of claim 1, wherein the true classification is indicative of a first vendor associated with the first wireless device, and
the true classification comprises
an identification of the first vendor and the estimated classification comprises an estimate of the identification of the first vendor, or
an identity value associated with a group of vendors comprising the first vendor and the estimated classification comprises an estimate of the identity value.

4. (canceled)

5. (canceled)

6. The method of claim 1, further comprising:
receiving the first CSI training data (H1), set from a channel data service (CDS).

7. The method of claim 6, further comprising:
determining a reconstruction loss by comparing the first reconstructed CSI data set to the first CSI training data set; wherein the step of updating the first parameters and the second parameters is further based on the reconstruction loss; and
receiving the true classification from the first wireless device, wherein the step of determining the first loss comprises determining a cross entropy loss based on the estimated classification and the true classification.

8. (canceled)

9. (canceled)

10. The method of claim 1, further comprising:
obtaining a plurality of latent space representations of a respective plurality of CSI training data sets;
applying a clustering algorithm to the plurality of latent space representations to determine a plurality of clusters of the plurality of latent space representations;
for each cluster, determining a unique identity value, wherein the unique identity value is indicative of one or more vendors associated with the cluster;
determining that the first latent space representation belongs to a first cluster of the plurality of clusters; and
determining that the true classification comprises a first identity value associated with first cluster.

11. (canceled)

12. The method of claim 7, wherein the step of updating the first parameters and the second parameters comprises performing back-propagation based on the first loss and the reconstruction loss, the method further comprising:
transmitting one or more gradient values resulting from the back-propagation to the first wireless device.

13. (canceled)

14. The method of claim 1, wherein the first ML model comprises a neural network and wherein the step of decoding the first latent space representation is performed using first layers of the neural network comprising the first parameters.

15. The method of claim 14, wherein the step of classifying the first latent space representation to estimate the estimated classification is performed using second layers of the neural network comprising the second parameters, wherein
the first parameters and the second parameters are shared between the first layers of the neural network and the second layers of the neural network, or
a distance between the first parameters and the second parameters is regulated.

16. (canceled)

17. (canceled)

18. A method of training a second machine learning (ML) model associated with a first wireless device, the method comprising:
encoding, using first parameters of the second ML model, a first channel state information (CSI), training data set (H1), and an identification of a first vendor to generate a first latent space representation;
transmitting the first latent space representation to a first network node;
classifying, using second parameters of the second ML model, the first CSI training data set and the identification of the first vendor to generate an estimated classification;
determining a first loss based on the estimated classification and a true classification; and
updating the first parameters and the second parameters based on the determined first loss.

19. The method of claim 18, wherein the second ML model comprises an encoder module of an autoencoder.

20. The method 19 of claim 18, wherein the true classification is indicative of the first vendor associated with the first network node, and the true classification comprises:
the identification of the first vendor and the estimated classification comprises an estimate of the identification of the first vendor, or
an identity value associated with a group of vendors comprising the first vendor and the estimated classification comprises an estimate of the identity value.

21. (canceled)

22. (canceled)

23. The method of claim 18, further comprising:
responsive to transmitting the first latent space representation to the first network node, receiving one or more gradients; and
wherein the step of updating the first parameters and the second parameters is further based on the one or more gradients.

24. The method of claim 18, further comprising:
receiving the first CSI training data set from a channel data service (CDS); or, receiving the true classification from a CDS.

25. (canceled)

26. The method of claim 18, wherein the step of determining the first loss comprises determining a cross entropy loss based on the estimated classification and the true classification.

27. The method of claim 18, further comprising:
obtaining a plurality of latent space representations (B), of respective pluralities of CSI training data sets;
applying a clustering algorithm to the plurality of latent space representations to determine a plurality of clusters of the plurality of latent space representations; and
for each cluster, determining a unique identity value, wherein the unique identity value is indicative of one or more vendors associated with the cluster.

28. The method of claim 27, wherein the method further comprises:
determining that the first latent space representations belongs to a first cluster of the plurality of clusters; and
determining that the true classification comprises a first identity value associated with first cluster.

29. The method of claim 18, wherein
the second ML model comprises a neural network,
the step of encoding the first CSI training data set and the first vendor is performed using a first layers of the neural network comprising the first parameters; and
the step of classifying the first CSI training data set to estimate the estimated classification is performed using a second layers of the neural network comprising the second parameters, wherein
the first parameters and the second parameters are shared between the first layers of the neural network and the second layers of the neural network, or
a distance between the first parameters and the second parameters is regulated.

30-34. (canceled)

35. A training apparatus for training a first machine learning (ML) model, the training apparatus comprising processing circuitry configured to cause the training apparatus to:
receive a first latent space representation of a first channel state information (CSI), training data set (H1), from a first wireless device;
decode, using first parameters of the first ML model, the first latent space representation to determine a first reconstructed CSI data set;
classify, using second parameters of the first ML model, the first latent space representation to estimate an estimated classification;
determine a first loss based on the estimated classification and a true classification; and update the first parameters and the second parameters based on the determined first loss.

36. (canceled)

37. A training apparatus for training a second machine learning (ML) model, the training apparatus comprising processing circuitry configured to cause the training apparatus to:
encode using first parameters of the second ML model, a first channel state information (CSI), training data set (H1), and an identification of a first vendor to generate a first latent space representation;
transmit the first latent space representation to a first network node;
classify, using second parameters of the second ML model, the first CSI training data set and the identification of the first vendor to generate an estimated classification;
determine a first loss based on the estimated classification and a true classification; and update the first parameters and the second parameters based on the determined first loss.

38-40. (canceled)
